(19) United States
(12) Patent Application Publication
(10) Pub. No.: US 2006/0027329 A1
(43) Pub. Date: Feb. 9, 2006

(54) Multi-frequency plasma enhanced process chamber having a torroidal plasma source

(76) Inventors: Ashok K. Sinha, Palo Alto, CA (US); Daniel J. Hoffman, Saratoga, CA (US); John P. Holland, San Jose, CA (US)

Correspondence Address: MOSER IP LAW GROUP / APPLIED MATERIALS, INC., 1040 BROAD STREET, 2ND FLOOR, SHREWSBURY, NJ, 07702, US

(21) Appl. No.: 10/914,947

(22) Filed: Aug. 9, 2004

(51) Int. Cl. C23F 1/00; B44C 1/22

(52) U.S. Cl. 156/345.48; 216/68

(57) ABSTRACT

A method and apparatus for processing a substrate includes a reactor chamber having a chamber wall and containing a substrate support. An electrode overlies the substrate and is spaced apart from the substrate support. One or more plasma sources maintains plasma in the reactor in one or more torroidal paths using a first frequency. One or more RF power generators supply power to the electrode at a second frequency that is different from the first frequency.

### BACKGROUND OF THE INVENTION

1. Field of the Invention

Embodiments of the present invention generally relate to a plasma enhanced semiconductor processing systems used to process substrates to manufacture devices such as microelectronic circuits, flat panel displays and the like and, in particular, the invention relates to plasma sources for such plasma enhanced semiconductor substrate processing systems.

2. Description of the Related Art

In modern plasma enhanced semiconductor substrate processing systems, high density plasmas have been employed in order to increase productivity or etch rate. In one type of system the high density plasma is formed by inductively coupling energy to the plasma. The process precursor gases tend to dissociate rapidly in a high density plasma creating a high plasma content of free radicals. High plasma densities, although beneficial to etch rate can damage the substrate or features thereon.

An issue with high density inductively coupled plasma reactors particularly of the type having an overhead coil antenna facing the substrate or substrates is that the power applied to the coil antenna is increased to enhance the etch rate. The substrate to ceiling gap must be sufficiently large so that the power is absorbed in the plasma region well above the substrate. This avoids a risk of device damage on the substrate due to strong electromagnetic fields. Moreover, for high levels of radio frequency (RF) power applied to the overhead coil antenna the substrate-to-ceiling gap must be relatively large and therefore a small gap is difficult to obtain.

A torroidal reactor is one type of an inductively coupled plasma reactor. In a torroidal reactor, the plasma is formed at a location that is remote for the process area and the plasma flows from the plasma formation region through the process area via a circular path. An issue presented by torroidal reactors is that at high current densities, the plasma doesn't cover the full diameter of the substrate, i.e., the plasma is not uniformly distributed across the substrate. As the current density increases, the area of the substrate covered by the plasma decreases. Consequently, at high current densities the resulting etch becomes less uniform.

Therefore, there is a need in the art for a technique to improve etch uniformity in a torroidal reactor.

### SUMMARY OF THE DISCLOSURE

The invention is a plasma enhanced process reactor for processing a substrate comprising a chamber, a torroidal plasma source, a substrate support pedestal and a capacitive electrode. The torroidal source is coupled to the chamber to provide plasma flow within the chamber. The capacitive electrode is positioned in the chamber proximate the substrate to capacitively couple energy to the plasma in the chamber and uniformly distribute the plasma across the substrate. To facilitate plasma uniformity, the torroidal source operates at a first frequency and the energy supplied to the capacitive electrode operates at a second frequency, where the first and second frequencies are different.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a plasma reactor that maintains an overhead torroidal plasma current path and controls the plasma using a plurality of frequency sources having different frequencies in accordance with one embodiment of the invention;

FIG. 2 is a side view of the illustration corresponding to prior FIG. 1;

FIG. 3 is an illustration of a variation of FIG. 1 in which a closed magnetic core is employed; and

FIG. 4 is an illustration a plasma reactor that maintains a pair of mutually orthogonal torroidal plasma currents across the surface of the substrate and controls the plasma using a plurality of frequency sources having different frequencies in accordance with one embodiment of the invention.

### DETAILED DESCRIPTION

The invention is a torroidal reactor having one or more torroidal plasma sources for producing a plasma and a capacitively coupled electrode proximate the substrate, where the electrode uniformly distributes the plasma across the substrate. The one or more torroidal plasma sources maintain the plasma in one or more torroidal paths. The paths carry the plasma through a process area proximate the substrate. The electrode is powered with one or more RF frequencies that are different than the frequencies used for the torroidal plasma sources. The resulting plasma is uniformly distributed over the substrate.

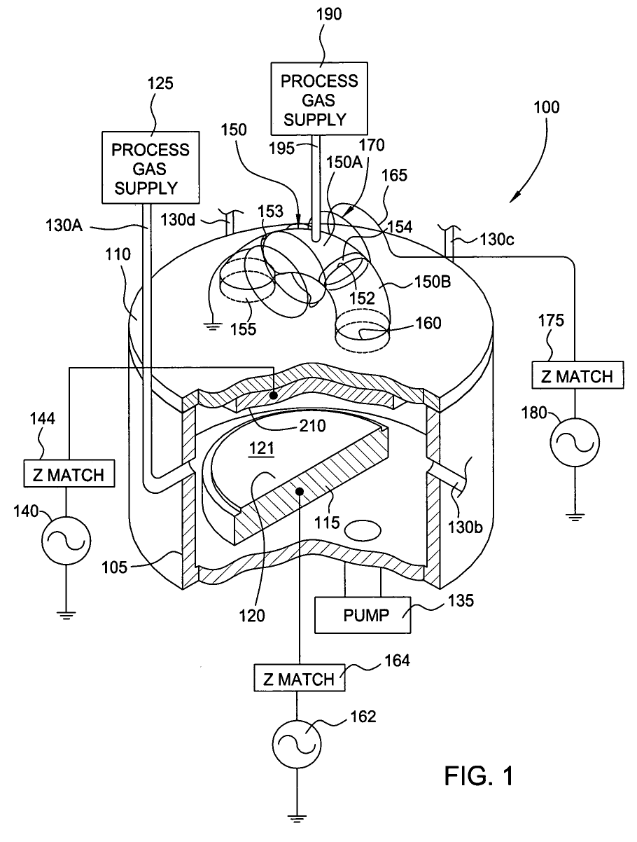

FIG. 1 illustrates a torroidal plasma reactor chamber 100 enclosed by a cylindrical side wall 105 and a ceiling 110 houses a substrate pedestal 115 for supporting a semiconductor substrate or substrate 120. A process gas supply 125 furnishes process gas into the chamber 100 through gas inlet nozzles 130a-130d extending through the side wall 105. A vacuum pump 135 controls the pressure within the chamber 100, typically maintaining the pressure below 0.5 milliTorr (mT). A half-torroidal hollow tube enclosure or conduit 150 extends above the ceiling 110 in a half circle. The conduit 150, although extending externally outwardly from ceiling 110, is nevertheless part of the reactor and forms a wall of the chamber. Internally it shares the same evacuated atmosphere as exists elsewhere in the reactor. The vacuum pump 135, instead of being coupled to the bottom of the main part of the chamber as illustrated in FIG. 1, may instead be coupled to the conduit 150. The conduit 150 has one open end sealed around a first opening 155 in the reactor ceiling 110 and its other end sealed around a second opening 160 in the reactor ceiling 110. The two openings or ports 155, 160 are located on generally opposite sides of the substrate support pedestal 115. The hollow conduit 150 is reentrant in that it provides a flow path that exits the main portion of the chamber at one opening and re-enters at the other opening. In this specification, the conduit 150 may be described as being half-torroidal, in that the conduit is hollow and provides a portion of a closed path in which plasma may flow, the entire path being completed by flowing across the entire process region overlying the substrate support pedestal 115. Notwithstanding the use of the term “torroidal”, the trajectory of the path as well as the cross-sectional shape of the path or conduit 150 may be circular or non-circular, and may be square, rectangular or any other shape either a regular shape or irregular.

The external conduit 150 may be formed of a relatively thin conductor such as sheet metal, but sufficiently strong to withstand the vacuum within the chamber. In order to suppress eddy currents in the sheet metal of the hollow conduit 150 (and thereby facilitate coupling of an RF inductive field into the interior of the conduit 150), an insulating gap 152 extends across and through the hollow conduit 150 so as to separate the conduit 150 into two tubular sections 150A, 150B. The gap 152 is filled by a ring 154 of insulating material such as a ceramic in lieu of the sheet metal skin, so that the connection of the sections 150, 150B across the gap 152 is vacuum tight. A second insulating gap and ring (depicted by dash line 153) may be provided, so that one section of the conduit 150 is electrically floating.

A bias RF generator 162 applies RF bias power to the substrate pedestal 115 and substrate 120 through an impedance match element 164. RF generator 140 applies RF power to an overhead electrode 210 through an impedance match element 144.

Alternatively, the hollow conduit 150 may be formed of a non-conductive material instead of the conductive sheet metal. The non-conductive material may be a ceramic, for example. In such an alternative embodiment, one or more insulating gaps 152,153 are not required.

An antenna 170 such as a winding or coil 165 disposed on one side of the hollow conduit 150 and wound around an axis parallel to the axis of symmetry of the half-torroidal tube is connected through an impedance match element 175 to an RF power source 180. The antenna 170 may further include a second winding 185 disposed on the opposite side of the hollow conduit 150 and wound in the same direction as the first winding 165 so that the magnetic fields from both windings add constructively.

Process gases from the chamber 100 fill the hollow conduit 150. Optionally, a separate process gas supply 190 may supply process gases directly in to the hollow conduit 150 through a gas inlet 195. The RF field in the external hollow conduit 150 ionizes the gases in the tube to produce a plasma. The RF field induced by the circular coil antenna 170 is such that the plasma formed in the tube 150 reaches through a region 121 defined between the substrate 120 and the ceiling 110 to complete a torroidal path that includes the half-torroidal hollow conduit 150. As employed herein, the term “torroidal” refers to the closed and solid nature of the path, but does not refer or limit its cross-sectional shape or trajectory, either of which may be circular or non-circular or square or otherwise. Plasma circulates through the complete torroidal path or region which may be thought of as a closed plasma circuit. The torroidal region extends across the diameter of the substrate 120 and, in certain embodiments, has a sufficient width in the plane of the substrate so that it overlies the entire substrate surface.

The RF inductive field from the coil antenna 170 includes a magnetic field which itself is closed (as are all magnetic fields), and therefore induces a plasma current along the closed torroidal path described here. It is believed that power from the RF inductive field is absorbed at generally every location along the closed path, so that plasma ions are generated all along the path. The RF power absorption and rate of plasma ion generation may vary among different locations along the closed path depending upon a number of factors. However, the current is generally uniform along the closed path length, although the current density may vary. This current alternates at the frequency of the RF signal applied to the antenna 170. However, since the current induced by the RF magnetic field is closed, the current must be conserved around the circuit of the closed path, so that the amount of current flowing in any portion of the closed path is generally the same as in any other portion of the path. As will be described below, this fact is exploited in the invention to great advantage.

The closed torroidal path through which the plasma current flows is bounded by plasma sheaths formed at the various conductive surfaces bounding the path. These conductive surfaces include the sheet metal of the hollow conduit 150, the substrate (and/or the substrate support pedestal) and the ceiling overlying the substrate. The plasma sheaths formed on these conductive surfaces are charge-depleted regions produced as the result of the charge imbalance due to the greater mobility of the low-mass negative electrons and the lesser mobility of the heavy-mass positive ions. Such a plasma sheath has an electric field perpendicular to the local surface underlying the sheath. Thus, the RF plasma current that passes through the process region overlying the substrate is constricted by and passes between the two electric fields perpendicular to the surface of the ceiling facing the substrate and the surface of the substrate facing the gas distribution plate. The thickness of the sheath (with RF bias applied to the substrate or other electrode) is greater where the electric field is concentrated over a small area, such as the substrate, and is less in other locations such as the sheath covering the ceiling and the large adjoining chamber wall surfaces. Thus, the plasma sheath overlying the substrate is much thicker. The electric fields of the substrate and ceiling/gas distribution plate sheaths are generally parallel to each other and perpendicular to the direction of the RF plasma current flow in the process region.

When RF power is first applied to the coil antenna 170, a discharge occurs across the gap 152 to ignite a capacitively coupled plasma from gases within the hollow conduit 150. In one embodiment of the invention, the RF generator 180 operates at less than or equal to about 5 KW at about 2 to 100 MHz. Thereafter, as the plasma current through the hollow conduit 150 increases, the inductive coupling of the RF field becomes more dominant so that the plasma becomes an inductively coupled plasma. Alternatively, plasma may be initiated by other means, such as by RF bias applied to the substrate support or other electrode. The RF bias source 162 operates at 1 to 15 MHz and less than about 8 KW.

In order to avoid edge effects at the substrate periphery, the ports 155, 160 are separated by a distance that exceeds the diameter of the substrate. For example, for a 12 inch diameter substrate, the ports 155, 160 are about 16 to 22 inches apart. For an 8 inch diameter substrate, the ports 155, 160 are about 10 to 16 inches apart.

The chamber 100 is bounded above by the overhead electrode 210 supported above the substrate 120. The overhead electrode 210 is positioned to provide capacitively coupled energy to the plasma in the chamber 100. An RF generator 140 applies less than about 4 KW of RF power at about 60 to 215 MHz to the electrode 210. The plasma can be controlled and the process window widened by applying RF power at multiple frequencies to the overhead electrode 210 and the substrate support pedestal 115 as described in detail below. To facilitate improved plasma distribution over the substrate, the frequency(ies) applied to the electrode 210 are different from the frequency used by the torroidal source.

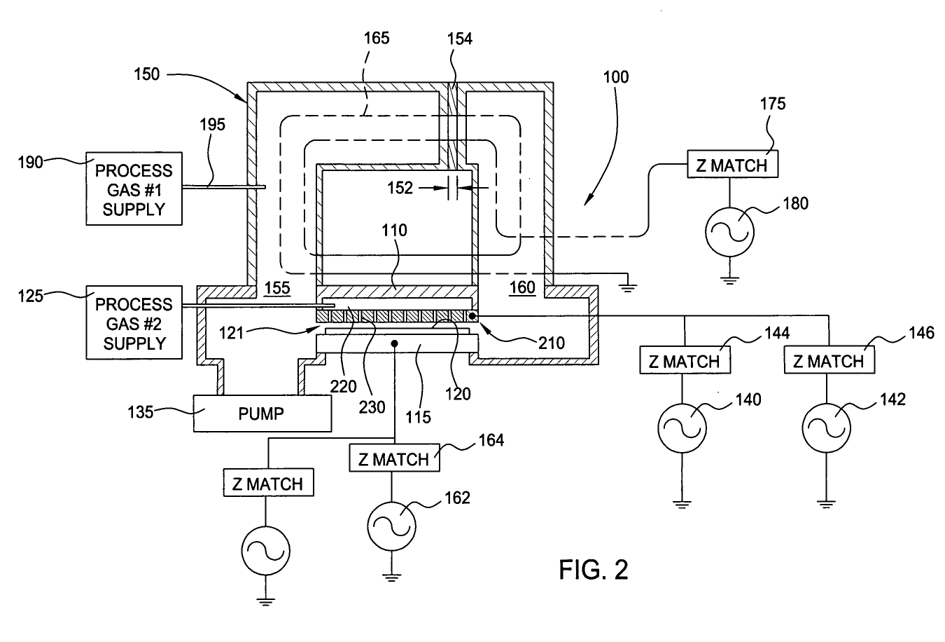

One way of realizing higher plasma density near the substrate surface by reducing plasma path cross-sectional area over the substrate is to reduce the substrate-to-ceiling gap length. This may be accomplished by simply reducing the ceiling height or by introducing a conductive gas distribution plate or showerhead over the substrate, as illustrated in FIG. 2 the showerhead forms the overhead electrode 210. The gas distribution showerhead 210 of FIG. 2 consists of a gas distribution plenum 220 connected to the gas supply 125 and communicating with the process region over the substrate 120 through plural gas nozzle openings 230. The advantage of the conductive showerhead 210 is two-fold: First, by virtue of its close location to the substrate, it constricts the plasma path over the substrate surface and thereby increases the density of the plasma current in that vicinity. Second, it provides a uniform electric field to and across the entire substrate surface.

In one embodiment, each opening 230 is relatively small, on the order of a millimeter (preferred hole diameter is approximately 0.5 mm) in order to avoid arcing across the openings 230. The spacing between adjacent openings may be on the order of a several millimeters.

The conductive showerhead 210 constricts the plasma current path rather than providing a short circuit through itself because a plasma sheath is formed around the portion of the showerhead surface immersed in the plasma. The sheath has a greater impedance to the plasma current than the space between the substrate 120 and the showerhead 210, and therefore all the plasma current goes around the conductive showerhead 210. One or more RF power generators 140, 142 at frequencies of 162 and 215 MHz and power levels of less than about 4 KW, may be coupled to showerhead 210 in order to provide greater control of the plasma and provide a wider process window. In one embodiment, the power applied by the generators 140, 142 is about 5 KW, the bias power is about 5 KW, and the power applied to the electrode is about 2 KW.

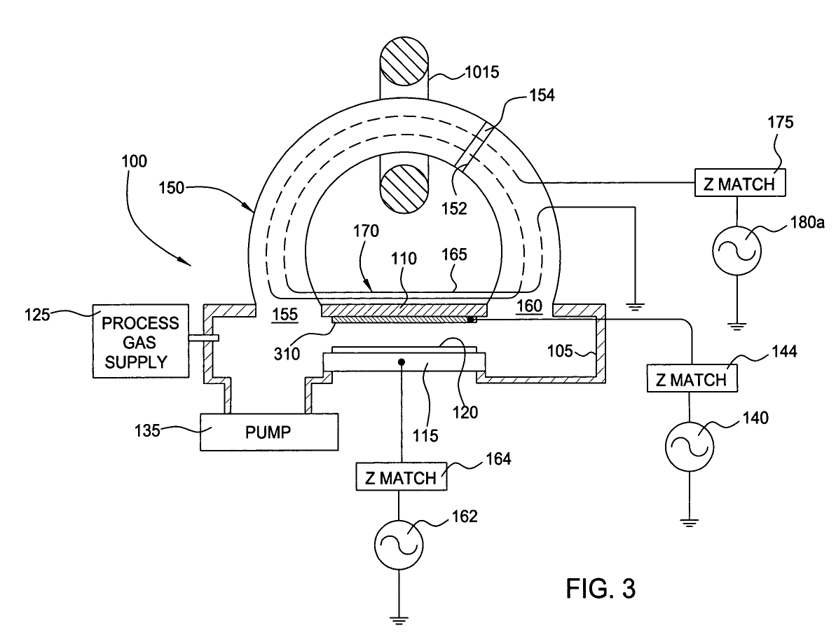

It is not necessary to employ a showerhead (e.g., the showerhead 210) in order to constrict the torroidal plasma current or path in the vicinity of the process region overlying the substrate. The path constriction and consequent increase in plasma ion density in the process region may be achieved by replacing the showerhead with an electrode 310 (shown in FIG. 3) by similarly reducing the substrate-to-ceiling height. A simple electrode (e.g., a conductive plate) attached to the ceiling, or the ceiling itself can be powered by the power source 140 to form the electrode. If the showerhead is replaced by an electrode in this manner, then the process gases may be supplied into the chamber interior by means of conventional gas inlet nozzles (not shown).

Different mixtures of reactive and inert process gas ratios may be introduced to showerhead 210 through different orifices 230 at different radii, in order to finely adjust the uniformity of plasma effects on photoresist. Thus, for example, a greater proportion of inert gas to reactive gas may be supplied to the orifices 230 lying outside a median radius while a greater proportion of reactive gas to inert gas may be supplied to the orifices 230 within that median radius.

As will be described below, another way in which the torroidal plasma current path may be constricted in the process region overlying the substrate (in order to increase plasma ion density over the substrate) is to increase the plasma sheath thickness on the substrate by increasing the RF bias power applied to the substrate support pedestal. Since as described previously the plasma current across the process region is confined between the plasma sheath at the substrate surface and the plasma sheath at the ceiling (or showerhead) surface, increasing the plasma sheath thickness at the substrate surface necessarily decreases the cross-section of the portion of the torroidal plasma current within process region, thereby increasing the plasma ion density in the process region. Thus, as will be described more fully later in this specification, as RF bias power on the substrate support pedestal is increased, plasma ion density near the substrate surface is increased accordingly.

In addition to applying bias power to the substrate support pedestal 115, the modulation of the plasma sheath thickness may also be controlled by applying RF power to the electrode 210. Using one or more RF sources 140, 142 to apply power to showerhead 210/electrode 310 at frequencies that are different than the frequency used to maintain the plasma causes the plasma to spread and more uniformly cover the substrate.

The reactor of FIGS. 1 and 2 has a silicon dioxide-to-photoresist etch selectivity as high as that of a capacitively coupled plasma reactor (about 7:1) while providing high etch rates approaching that of a high density inductively coupled plasma reactor. It is believed that the reason for this success is that the reactor structure of FIGS. 1 and 2 reduces the degree of dissociation of the reactive process gas, typically a fluorocarbon gas, so as to reduce the incidence of free fluorine in the plasma region over the substrate 120. Thus, the proportion of free fluorine in the plasma relative to other species dissociated from the fluorocarbon gas is desirably reduced. Such other species include the protective carbon-rich polymer precursor species formed in the plasma from the fluorocarbon process gas and deposited on the photoresist as a protective polymer coating. They further include less reactive etchant species such as CF and CF₂ formed in the plasma from the fluorocarbon process gas. Free fluorine tends to attack photoresist and the protective polymer coating formed thereover as vigorously as it attacks silicon dioxide, thus reducing oxide-to-photoresist etch selectivity. On the other hand, the less reactive etch species such as CF₂ or CF tend to attack photoresist and the protective polymer coating formed thereover more slowly and therefore provide superior etch selectivity.

It is believed the reduction in the dissociation of the plasma species to free fluorine is accomplished in the invention by reducing the residency time of the reactive gas in the plasma. This is because the more complex species initially dissociated in the plasma from the fluorocarbon process gas, such as CF₂ and CF are themselves ultimately dissociated into simpler species including free fluorine, the extent of this final step of dissociation depending upon the residency time of the gas in the plasma. The term “residency time” or “residence time” as employed in this specification corresponds generally to the average time that a process gas molecule and the species dissociated from the that molecule are present in the process region overlying the substrate or substrate. This time or duration extends from the initial injection of the molecule into the process region until the molecule and/or its dissociated progeny are pass out of the process region along the closed torroidal path described above that extends through the processing zone.

As stated above, etch selectivity is enhanced by reducing the residency time in the process region of the fluorocarbon process gas. The reduction in residency time is achieved by constricting the plasma volume between the substrate 120 and the ceiling 110.

The reduction in the substrate-to-ceiling gap or volume has certain beneficial effects. First, it increases plasma density over the substrate, enhancing etch rate. Second, residency time falls as the volume is decreased. As referred to above, the small volume is made possible in the present invention because, unlike conventional inductively coupled reactors, the RF source power is not deposited within the confines of the process region overlying the substrate but rather power deposition is distributed along the entire closed torroidal path of the plasma current. Therefore, the substrate-to-ceiling gap can be less than a skin depth of the RF inductive field, and in fact can be so small as to significantly reduce the residency time of the reactive gases introduced into the process region, a significant advantage.

There are two ways of reducing the plasma path cross-section and therefore the volume over the substrate 120. One is to reduce the substrate-to-showerhead gap distance. The other is to increase the plasma sheath thickness over the substrate by increasing the RF power applied to the substrate pedestal 115 and/or electrode 210, as briefly mentioned above. Either method results in a reduction in free fluorine content of the plasma in the vicinity of the substrate 120 (and consequent increase in dielectric-to-photoresist etch selectivity) as observed using optical emission spectroscopy (OES) techniques. One or more RF power generators 141, 162 operating at various frequencies may be coupled to substrate pedestal 115 in order to provide greater control of the plasma and provide a wider process window.

There are three additional methods of the invention for reducing free fluorine content to improve etch selectivity. One method is to introduce a non-chemically reactive diluent gas such as argon into the plasma. Preferably, the argon gas is introduced outside and above the process region by injecting it directly into the hollow conduit 150 from the second process gas supply 190, while the chemically reactive process gases (fluorocarbon gases) enter the chamber only through the showerhead 210. With this advantageous arrangement, the argon ions, neutrals, and excited neutrals propagate within the torroidal path plasma current and through the process region across the substrate surface to dilute the newly introduced reactive (e.g., fluorocarbon) gases and thereby effectively reduce their residency time over the substrate. Another method of reducing plasma free fluorine content is to reduce the chamber pressure. A further method is to reduce the RF source power applied to the coil antenna 170.

FIG. 3 is an embodiment of the invention that is similar to the embodiment shown in FIG. 1. The embodiment of FIG. 3 adds a closed magnetically permeable core 1015 that extends through the space between the ceiling 110 and the hollow conduit 150. The core 1015 improves the inductive coupling from the antenna 170 to the plasma inside the hollow conduit 150. All other elements of FIG. 3 operate as described above.

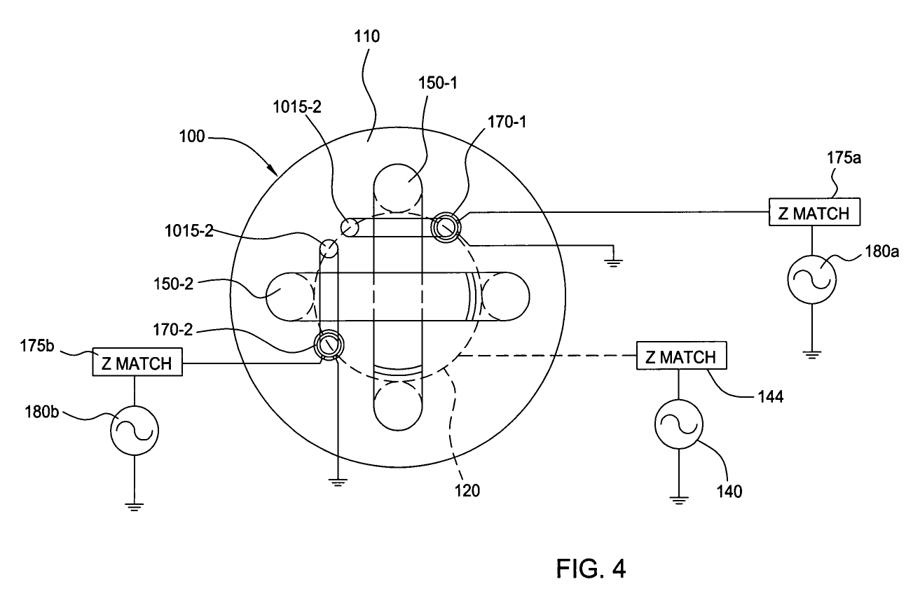

FIG. 4 is an embodiment of the invention illustrating a pair of orthogonal tube enclosures 150-1 and 150-2 extending through respective ports in the ceiling 110 and excited by respective coil antennas 170-1 and 170-2. Each tube 150-1, 150-2 is configured similar to the conduit tube 150. Individual cores 1015-1 and 1015-2 are within the respective coil antennas 170-1 and 170-2. This embodiment creates two mutually orthogonal torroidal plasma current paths over the substrate 120 for enhanced uniformity. The two orthogonal torroidal or closed paths are separate and independently powered as illustrated, but intersect in the process region overlying the substrate, and otherwise do not interact. In order to assure separate control of the plasma source power applied to each one of the orthogonal paths, the frequency of the respective RF generators 180a, 180b of FIG. 4 are different, so that the operation of the impedance match circuits 175a, 175b is decoupled. For example, the RF generator 180a may produce an RF signal at 11 MHz while the RF generator 180b may produce an RF signal at 12 MHz. Alternatively, independent operation may be achieved by offsetting the phases of the two RF generators 180a, 180b. The chamber 100 houses a substrate support pedestal (not shown) for supporting a substrate 120. An RF power source (not shown) may be coupled to the substrate support pedestal to apply RF bias power at 1 to 15 MHz and less than 15 KW to the substrate support pedestal. The chamber 100 is bounded above by an overhead electrode 210 supported above the substrate 120. An overhead electrode (not shown) is positioned at a top portion of the chamber 100 to provide capacitively coupled energy to the plasma. An RF generator 140 applies RF power at 60-200 MHz and less than 4 KW to the electrode. In one embodiment, the power applied by the generators 180a, 180b is about 5 KW, the bias power is about 5 KW, and the power applied to the electrode is about 2 KW. The plasma can be controlled and the process window widened by applying RF power in multiple frequencies to the overhead electrode and/or the substrate support pedestal, where the frequencies applied to the pedestal and/or the electrode are different from the frequency(ies) applied to the coil antennas 170-1 and 170-2.

While the foregoing is directed to embodiments of the present invention, other and further embodiments of the invention may be devised without departing from the basic scope thereof, and the scope thereof is determined by the claims that follow.

1. A plasma reactor for processing a substrate, comprising:
a reactor chamber having a chamber wall and containing a substrate support;
an electrode overlying said substrate and spaced apart from the substrate support;
one or more plasma sources capable of maintaining plasma in one or more torroidal paths using a first frequency;
one or more RF power generators, where said one or more RF power generators supplies power at a second frequency to said electrode, where the first frequency is different from the second frequency.

2. The reactor of claim 1, further comprising:
a bias power RF generator, where the bias power RF generator supplies power at a third frequency to said substrate support.

3. The reactor of claim 1, wherein said electrode and said substrate support define a process region therebetween extending generally across a diameter of said substrate support.

4. The plasma reactor of claim 3, wherein the one or more torroidal paths extend across the process region and are generally parallel to the substrate.

5. The method of claim 1, wherein the first frequency is about 60 to 215 MHz.

6. The method of claim 1, wherein the first frequency is about 162 MHz and the second frequency is about 215 MHz.

7. The method of claim 2, wherein the third frequency is about 1 to 15 MHz.

8. The reactor of claim 1, wherein the one or more plasma sources apply less than about 8 KW to maintain the plasma within the one or more torrodial paths.

9. The reactor of claim 1, wherein the one or more RF generators provide less than 4 KW of power to the electrode.

10. A method of processing a substrate in a plasma reactor, comprising:
establishing a torroidal path for a plasma current to flow that passes near and transverse to a surface of the substrate;
maintaining a plasma current in said torroidal path by applying RF power at a first frequency to a portion of said torroidal path away from the surface of the substrate;
increasing ion density of the plasma current in the vicinity of the substrate by constricting an area of a portion of said torroidal path overlying the substrate;
controlling a plasma current in said torroidal path by coupling RF power at a second frequency to a region proximate the substrate, where the first frequency and the second frequency are different.

11. The method of claim 10, wherein constricting the area comprises applying an RF bias power to a substrate support that supports the substrate proximate the torroidal path.

12. The reactor of claim 10 further comprising:
a bias power RF generator, where the bias power RF generator supplies power at a third frequency to said substrate support.

13. The reactor of claim 10, wherein said electrode and said substrate support define a process region therebetween extending generally across a diameter of said substrate support.

14. The plasma reactor of claim 13, wherein the one or more torroidal paths extend across the process region and are generally parallel to the substrate.

15. The method of claim 10, wherein the first frequency is about 60 to 215.

16. The method of claim 15, wherein the first frequency is about 162 MHz and the second frequency is about 215 MHz.

17. The method of claim 10, wherein the step of maintaining a plasma current by applying the first RF power further comprises applying less than or equal to about 8 KW.

18. The method of claim 10, wherein the power applied at the second frequency is less than about 4 KW.

19. The method of claim 11, wherein the RF bias power is less than about 4 KW.

20. The method of claim 14 wherein the third frequency is about 1 to 15 MHz.
